(19) United States
(12) Patent Application Publication
(10) Pub. No.: US 2005/0240919 A1
(43) Pub. Date: Oct. 27, 2005

(54) Firmware update using memory card reader

(76) Inventors: Kyoug Il Kim, Sunnyvale, CA (US); Stanley S. Xu, San Jose, CA (US); Yancy Chen, Campbell, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/832,597

(22) Filed: Apr. 27, 2004

(51) Int. Cl. G06F 9/44

(52) U.S. Cl. 717/168

(57) ABSTRACT

Apparatus and methods are provided for updating firmware on a multimedia device. One method includes reading a firmware version from a memory card in a memory card reader of the multimedia device and selecting whether to update a firmware version in a memory of the multimedia device based on a comparison of the firmware version on the memory card to the firmware version in the memory of the multimedia device.

### INTRODUCTION

In today's information environment numerous intelligent devices are run and controlled by ever evolving software and/or firmware systems. Sometimes with new software and/or firmware releases glitches can occur in the programming which merit repair through updates. Additionally, new versions of firmware and/or software can be released post product shipment to include feature enhancement and/or added functionality. Thus, there is an ongoing usefulness to perform software and/or firmware updates to products in the field.

Firmware updates to computing devices can be performed by downloading a file through a serial interface, Ethernet, or wireless connection in a network environment. Such firmware updates employ the use of a network connection, e.g., a serial or Ethernet connection, along with a software utility and/or particular software interface application on the computing device, e.g., a serial terminal or other particular software routine). Other approaches include a network infrastructure having a wireless access point and gateway. Each of these example infrastructures involves a configuration process for software and/or hardware. The configuration process provides opportunity for incorrect operator setup. Additionally, network interruptions can interfere with the firmware update.

### BRIEF DESCRIPTION OF THE DRAWINGS

FIG. 1A illustrates a hardwire connection between a computing device and a multimedia device.

FIG. 1B illustrates a hardwire connection between a computing device and a multimedia device through a network gateway/hub.

FIG. 1C illustrates a network infrastructure including wireless access points.

FIG. 2 illustrates an embodiment of a firmware update transfer between a computing device and a multimedia device using a memory card.

FIG. 3 illustrates a method embodiment for performing a firmware update using a memory card.

FIG. 4 illustrates another method embodiment for performing firmware updates.

### DETAILED DESCRIPTION

Embodiments of the present invention include program instructions which can execute to perform a firmware update to a multimedia device using a memory card. The embodiments can accommodate multiple memory cards formats. No external connection to a computer and/or software utility for downloading firmware to the multimedia device is involved. Embodiments facilitate an efficient and reliable serviceability technique for firmware updates in the field, factory, and/or user's home once new firmware is stored in the memory card. Embodiments allow for all update operation to be performed locally on the multimedia device.

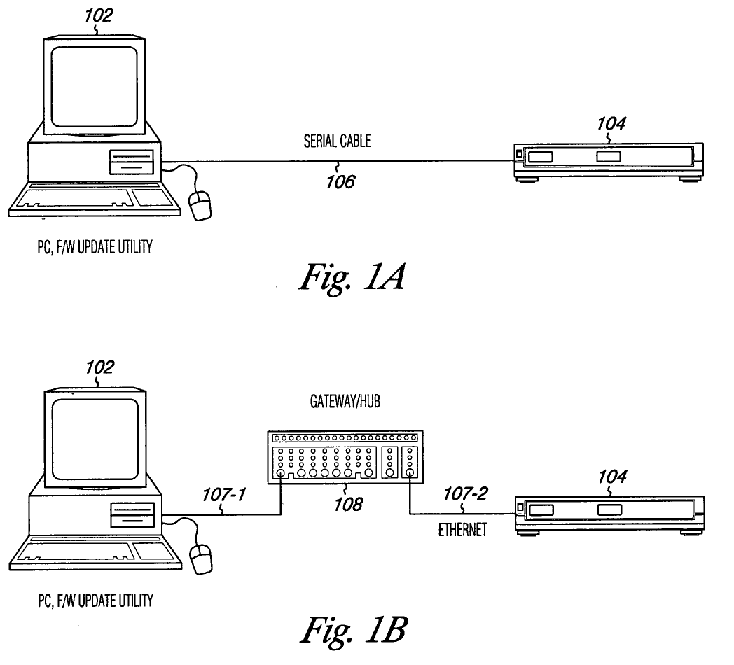

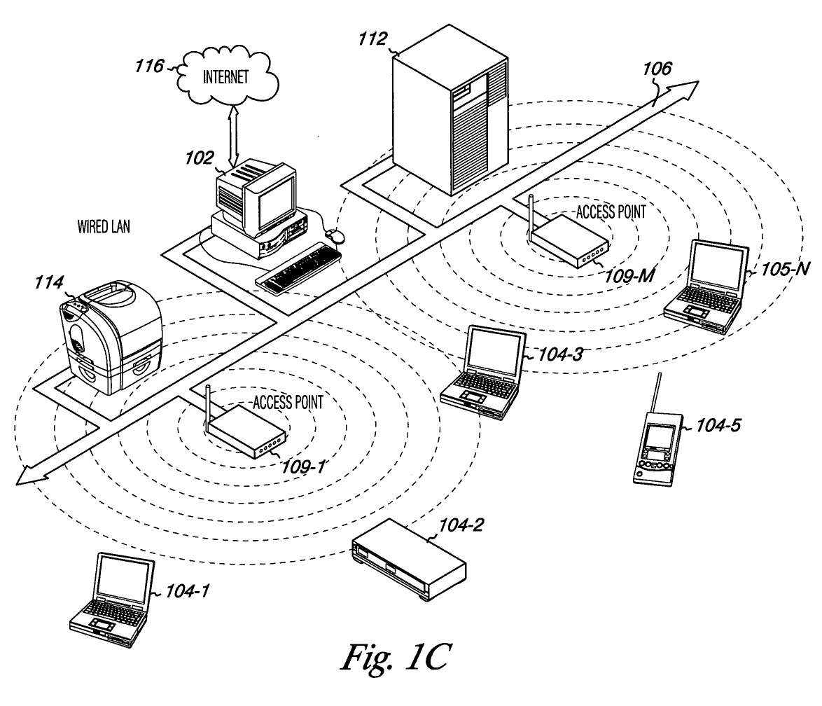

FIG. 1A illustrates a hardwire connection between a computing device 102 and a multimedia device 104. As one of ordinary skill in the art will appreciate upon reading this disclosure a computing device 102 includes processor and memory resources. Similarly, a multimedia device 102 can include processor and memory resources sizeable as suited to a particular implementation, as the same will be known and understood to one of ordinary skill in the art.

Computing and multimedia devices are widely used in consumer and commercial environments. Such devices generally include a user interface that is responsive to user input in complement to the processor and memory resources. The user interface can be in the form of a touch screen display, a keyboard and/or keypad, and a pointing device such as a mouse or stylus. Memory can include some combination of ROM, dynamic RAM, and/or some type of nonvolatile and writeable memory such as battery-backed persistent storage, e.g., a hard disk drive that stores programs and data. An operating system such as Windows, Unix, and/or Linux, etc. is also stored in the persistent storage. Further, a number of other applications programs such as computer games or an office suite can also be stored in the persistent storage. Computing devices may include a network interface application that communicates with a server over a network. The network interface application may be an Internet interface that communicates with the Internet using HTTP or other protocols.

Computing device 102 can include desktop personal computers (PCs), workstations and/or laptops, etc. A multimedia device 104 as used herein is intended to be differentiated and distinguished from computing devices such as PCs. As used herein, multimedia devices 104 are intended to include media players, media receivers, digital cameras, MP3 players, personal digital assistants (PDAs), television sets (e.g., flat screen televisions, high definition TVs (HDTVs), digital televisions with built-in memory card readers, HDTV Tuner set-top boxes with internal and/or external memory card readers, and/or plasma displays), digital versatile disk (DVD) players, and/or cell phones, etc. All of these examples can include a wired and/or wireless network interface as the same will be known and understood by one of ordinary skill in the art.

As shown in FIG. 1A, the computing device 102 is connected to the multimedia device 104 via a hardwired connection, e.g., a serial cable, 106. FIG. 1A illustrates one approach to providing a firmware update to a multimedia device 104. As shown in FIG. 1A a software and/or firmware update may be received on a PC 102 from a portable storage media such as a floppy disk drive, CDROM, or hard disk. Alternatively, the update would be downloaded from a commonly accessible storage location such as a bulletin board or Internet web site to a persistent local storage device.

In FIG. 1A the computing device 102 would employ a particular software interface application to download the firmware update, e.g., an initial and/or subsequent firmware installation, from the computing device 102 through the hardwired connection 106 to a memory on the multimedia device 104. As one will appreciate, this process typically involves the use of a computing device software utility and configuration and setup for both the hardware and software. Also, in addition to involving the use of a hardwired connection 106 this process may involve bringing the multimedia device 104 to a location near the computing device 102.

FIG. 1B illustrates a hardwire connection between a computing device 102 and a multimedia device 104 through a network gateway/hub 108. As one of ordinary skill in the art will appreciate network devices can be connected to one another and/or to other networks via routers, hubs and/or switches as the same are know and understood by one of ordinary skill in the art, to form a local and/or wide area network (LAN/WAN). As such, different network devices, including peripherals and multimedia devices can be connected to share and communicate data. In Figure IB, the computing device 102 is illustrated connected via a hardwired network connection, e.g., an Ethernet connection 107-1 and 107-2, to the multimedia device 104.

As in FIG. 1A, the computing device 102 in FIG. 1B would employ a particular software interface application to download the firmware update, e.g., an initial and/or subsequent firmware installation, from the computing device 102 through the hardwired network connection 106 to a memory on the multimedia device 104. Again, this process typically involves the use of a computing device software utility as well as configuration and setup for both the hardware and software. For example, the software configuration may include entering a baud rate, stop bit, and/or IP address, etc. for performing the firmware download from the computing device 102 through the hardwired network connection 106 to a memory on the multimedia device 104.

FIG. 1C illustrates a network infrastructure including wireless access points, e.g., 109-1, . . . , 109-M. FIG. 1C illustrates a computing device 102 coupled over a LAN and/or WAN to a number of network devices using both hardwired and wireless connections. In FIG. 1C multiple multimedia devices 104-1, 104-2, 104-3, 104-4, 104-5, . . . , 104-N, are illustrated connected via wireless access points, 109-1 and 109-2, to the LAN and the computing device 102. The designators “N” and “M” are used to indicate that a number of access points and/or multimedia devices can be attached to the network 100. The number that N represents can be the same or different from the number represented by M. The multimedia devices, 104-1, 104-2, 104-3, 104-4, 104-5, . . . , 104-N, can include a number and variety multimedia device as the same have been described above. One of ordinary skill in the art will appreciate that the multimedia devices, 104-1, 104-2, 104-3, 104-4, 104-5, . . . , 104-N, can connect to the access points, 109-1, . . . , 109-M, according to a number of different wireless protocols, e.g., via RF, 802.11 standards and Bluetooth, etc.

The computing device 102 is illustrated connected to a server/database 112 over a hardwired network connection 106. A peripheral 114 such as a multifunction scanner, copier, and facsimile device is also shown connected to the computing device 102 in a hardwired manner. FIG. 1C further illustrates that the computing device 102 may have access to the Internet 116, e.g., in a manner known to one of ordinary skill in the art.

As in FIGS. 1A and 1B, firmware updates to the multimedia devices, 104-1, 104-2, 104-3, 104-4, 104-5, . . . , 104-N, can be performed by a download from the computing device 102 over the wired and wireless network infrastructure 100. However, once again, the network 100 would employ a particular software interface application to download the firmware update, e.g., an initial and/or subsequent firmware installation, from the computing device 102 through the hardwired network connection 106 and access points, 109- 1, . . . , 109-M, to respective memories among the various number and types of multimedia devices, the multimedia devices, 104-1, 104-2, 104-3, 104-4, 104-5, . . . , 104-N. As before, this process involves the use of a computing device software utility as well as configuration and setup for both the hardware and software to enter a baud rate, stop bit, and/or IP address, etc.

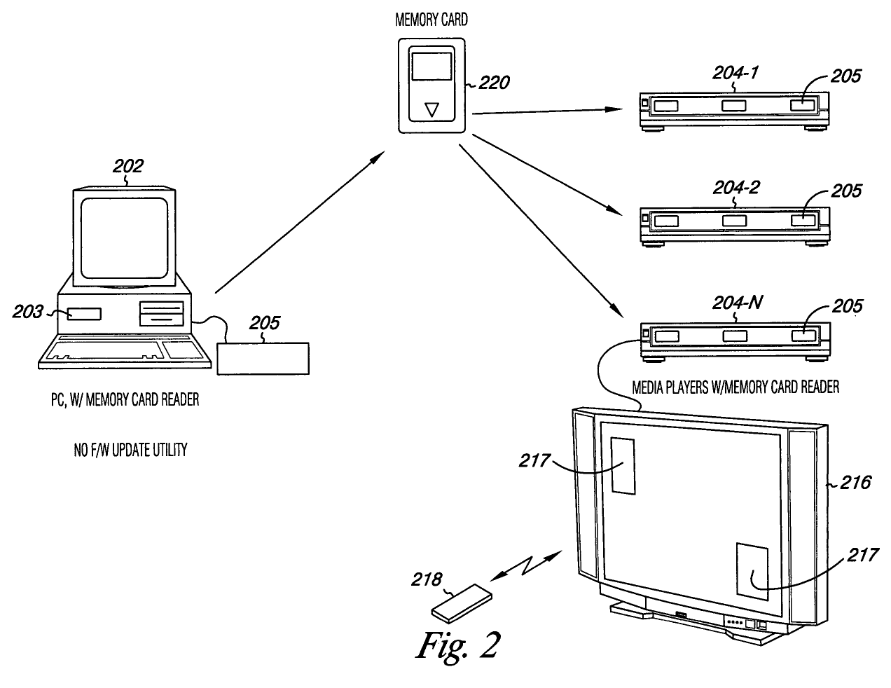

FIG. 2 illustrates an embodiment of a firmware update transfer between a computing device 202 and a multimedia device, illustrated as 204-1, 204-2, . . . , 204-N, using a memory card 220. The designated “N” is intended to represent that the firmware update transfer can be performed to a number of multimedia devices using a memory card 220. As shown in the embodiment of FIG. 2, a multimedia device, e.g., 204-N, can include, for example, a digital media player connected to an entertainment display 216 such as a standard television set, flat screen television, high definition TV (HDTV), and/or plasma display which can display various graphics 217 and can be operated by a remote control 218.

As used herein the term memory card is intended to be differentiated from other portable memory device mediums such as a floppy disk, compact disk (CD), and/or digital versatile disk (DVD). One of ordinary skill in the art will recognize this distinction. By way of example and not by way of limitation, those skilled in the art generally include memory sticks, secure digital cards, compact flash memory cards, smart media cards, extreme digital (xD) picture cards, and MMC (multimedia card), etc., with their individual structure and format types within the group classification of memory cards.

This distinction is drawn since it is recognized that firmware updates for purposes of updating firmware directly to a memory of a computing device have been performed by providing a portable memory medium, e.g., floppy disk, CD, and/or DVD to a respective memory drive in the computing device. Typically, once installed in the floppy, CD, and/or DVD memory drive a software utility is employed and/or a program is launched on the computing device to load the firmware update from this particular type and format of portable memory medium to the memory of the computing device.

More recently, memory cards have become a popular format and the physical structure of choice for porting data media content such as images, video and music. Embodiments described herein include various types of multimedia devices, including media players, media receivers, digital cameras, MP3 players, personal digital assistants (PDAs), television sets (e.g., flat screen televisions, high definition TVs (HDTVs), and/or plasma displays), digital versatile disk (DVD) players, and/or cell phones, etc, which are equipped with a memory card reader for memory cards. That is, multimedia devices include a data port suited to a particular type of memory card as the same have been described herein. Many personal computers (PCs) are likewise including internal and/or external memory card readers. Certain media players and/or multifunction devices will include memory card readers capable of reading various formats and types of memory cards as the same is known and understood by one of ordinary skill in the art. Again, to date, memory cards have been utilized primarily for the storage and transfer of media content including music, pictures, and video and not as a transfer medium for firmware updates.

In the embodiment of FIG. 2, the computing device 202 is illustrated including either a built-in memory card reader 203 and/or an external memory card reader 205 connected thereto, e.g., by a USB. Similarly, the multimedia devices, 204-1, 204-2, . . . , 204-N, are illustrated including a built in memory card reader, shown as 205, but could additionally or even alternatively include an external memory card reader as illustrated with the computing device 202. The memory card 220 can include the memory card types and formats mentioned above. However, embodiments are not limited to these examples.

According to various embodiments, the multimedia devices, 204-1, 204-2, . . . , 204-N, include program instructions which can be stored in memory and executed by a processor thereon to read a firmware version from a memory card, e.g., 220, provided to the memory card reader 205 of the multimedia device, e.g., 204-1, 204-2, . . . , 204-N. Additionally, the program instructions can execute to select whether to update a firmware version in the memory of the multimedia device, 204-1, 204-2, . . . , 204-N, based on a comparison of the firmware version on the memory card 220 to the firmware version the memory of the multimedia device, 204-1, 204-2, . . . , 204-N. That is, a memory card having a firmware update stored thereon can be mounted in a memory card reader 205 of a multimedia device, 204-1, 204-2, . . . , 204-N whereby the memory card will be recognized and mounted to the operating system (OS) files of the device, as the same will be known and understood to one of ordinary skill in the art. Thereafter program embodiments can be executed to search a firmware file and check its version from the memory card 220, as the same will be known and understood to one of ordinary skill in the art. The program embodiments can execute to compare the firmware version on the memory card 220 with a firmware version on the multimedia device, 204-1, 204-2, . . . , 204-N. The program embodiments can execute to provide a user with the selectability of whether to update the firmware version on the multimedia device, 204-1, 204-2, . . . , 204-N with the firmware version on the memory card 220 based on a result presented to the user and based upon input instructions from the user in response thereto.

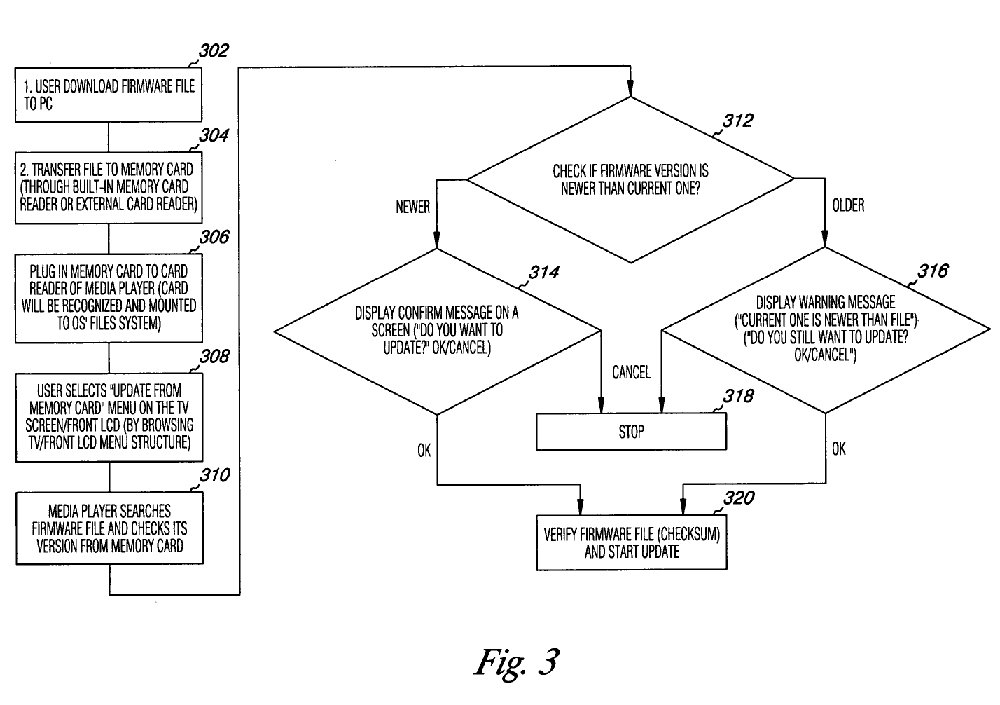

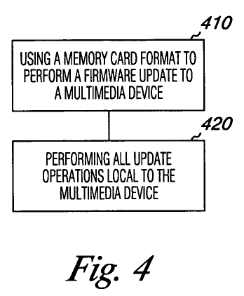

FIGS. 3 and 4 illustrate various method embodiments for updating firmware to a device using a memory card. As one of ordinary skill in the art will understand, the embodiments can be performed by software/firmware (e.g., computer executable instructions) operable on the devices shown herein or otherwise. The invention, however, is not limited to any particular operating environment or to software written in a particular programming language.

Unless explicitly stated, the method embodiments described herein are not constrained to a particular order or sequence. Additionally, some of the described method embodiments can occur or be performed at the same point in time.

FIG. 3 illustrates a method embodiment for performing a firmware update using a memory card. As shown in the embodiment of FIG. 3 the method includes downloading a firmware update, e.g., firmware file to a computing device, e.g., a personal computer, as shown in block 302. The firmware file can be downloaded to the computing device over a network connection as described in FIGS. 1A-1C. As one of ordinary skill in the art will appreciate it is becoming popular for users to download firmware updates from the Internet. For example, an Internet browser can be used to access a web server having a firmware update. A given firmware update can be selected by clicking a link which can then execute instructions along with the browser to download and install the firmware update to memory or a hard disk of the personal computer.

A computing device, e.g., desktop, laptop, workstation, etc., which is equipped with an internal and/or external memory card reader can employ the memory card reader to transfer a firmware update file from the memory of the computer to a memory card, as shown in block 304. One of ordinary skill in the art will appreciate the manner in which a memory card reader, such as illustrated in FIG. 2, operates and can be used to transfer a firmware update file from the memory, hard disk or otherwise, in a computer to a memory card. One of ordinary skill in the art will further appreciate the manner in which a memory card reader may be designed to accommodate memory cards of various form factors and formats, e.g. a smart media card, multimedia card (MMC), compact flash, memory stick, extreme digital (xD) picture card, secure digital card, etc. According to embodiments described herein a user can then remove and physically transfer the memory card to another multimedia device as illustrated in FIG. 2.

A multimedia device, e.g., a digital cameras, MP3 players, PDAs, digital media players, etc., which is equipped with an internal and/or external memory card reader can receive the physical memory card in the manner in which the personal computer did. Some multimedia devices, such as illustrated in FIG. 2, include memory card readers designed to accommodate memory card of various form factors and formats as well. A multimedia device, such as described above generally includes some form of display thereon, e.g., LCD, etc. Other multimedia devices such as digital media players may be connected to a display screen such as a standard television set, flat screen television, high definition TV (HDTV), and/or plasma display, e.g., media player 204-N connected to display 216 in FIG. 2. As was illustrated in connection with FIG. 2, such a display can be used to present various graphics 217 and can be operated by a remote control 218. Likewise, as one of ordinary skill in the art will appreciate, a multimedia device such as a media player may also be operated by a remote control, RF device. The multimedia device can also include other input mechanisms such as a touch screen thereon, input buttons, function keys, etc. The examples given herein are not intended to be limiting.

As illustrated in block 306 of the embodiment of FIG. 3, the method includes inserting (e.g., mounting) the memory card to a memory card reader on a multimedia device. Once the memory card is mounted in a given memory card reader the card will be identified. That is, the memory card will be recognized and mounted to the operating system (OS) files system of the multimedia device. One of ordinary skill in the art will appreciate the manner in which files are retrieved and a checksum process performed on a memory card by a memory card reading according to mounting various technologies. Program embodiments (e.g., computer executable instructions) are provided to a memory of the multimedia device that execute to display menu options to a user, e.g., content and/or menu presentation 217 on display 216 in FIG. 2 or on an LCD of the multimedia device, once the memory card is mounted.

As illustrated in block 308 of the embodiment of FIG. 3, the content and/or menu options offer a user the ability to select a firmware update from the memory card. For example, a user can select “update from memory card” a file menu option presented on a TV screen connected to a media player (having the program embodiments, memory card reader, and memory card mounted therein, using a remote control, e.g., shown as 204-N such as with the case of a media player 204-N, 216, 217, and 218 in FIG. 2. As another example, a user can select update from memory card on a touch screen, front LCD or other user interface mechanism on the multimedia device. Embodiments, however, are not limited to these examples.

As illustrated in block 310 of the embodiment of FIG. 3, the media player can execute instructions to search for a “Firmware File” in the memory card and can execute instructions to check its version. Program embodiments are provided to a memory of the multimedia device that execute to check if a given firmware version as contained on the memory card is newer or more recent than a firmware version resident in a memory on the multimedia device as illustrated in block 312. One of ordinary skill in the art will appreciate upon reading this disclosure the manner in which program instructions can be written and executed to retrieve and compare a firmware version, and information pertaining thereto, to a firmware version retrieved from or resident on another memory such as a memory in the multimedia device.

As shown in blocks 314 and 316 of the embodiment of FIG. 3, program instructions execute to display a confirm message on a display screen, e.g., a display screen as described above. For example, as illustrated in the embodiment of FIG. 3, when the program instructions execution and comparison determines that the firmware version present on the memory card is newer than the firmware version resident on the multimedia device, a prompt is provided to the user on the display screen such as “Do you want to update?” with additional options selectable such as “OK/Cancel”. Alternatively, when the program instructions execution and comparison determines that the firmware version present on the memory card is older than the firmware version resident on the multimedia device, a display warning message and/or prompt can be provided to the user on the display screen such as “Current firmware version (e.g., resident on the multimedia device) is newer than file (e.g., the firmware version on the memory card). Again, additionally options selectable by the user can be present such as “Do you still want to update?” and “OK/Cancel” options.

As described above, a user can input instructions in response to these prompts using a RF remote control device, input to a keypad on the multimedia device, and/or via a touch screen display, etc. As one of ordinary skill in the art will further appreciate the prompts themselves can be additionally and/or exclusively presented to a user in an audio format via a speaker and a user may input response instructions via audible commands using voice recognition software and a microphone on the present on a given multimedia device. Embodiments are not limited to these examples.

As illustrated in block 318 of the embodiment of FIG. 3, if a user inputs instructions to cancel then the program instructions can execute to stop and/or not to proceed with updating the firmware version on the memory card to a memory in the multimedia device. Alternatively, if a user inputs instructions selecting OK, e.g., to proceed, then the program instructions can execute to verify firmware file, e.g., perform a checksum routine as the same will be known and understood by one of skill in the art, and will execute to initiate and carry though the update of the firmware version on the memory card to a memory in the multimedia device. As one of ordinary skill in the art will appreciate upon reading this disclosure, the firmware update embodiments described herein are transparent to the user in that no particular software utilities and setup configurations are involved for the software or hardware. The firmware update is reliable because the operation has been performed internal, or locally, to the multimedia device. Hence, the firmware updates described herein provide an added degree of serviceability in the field, e.g., home environment, retail outlet, and/or factory setting, etc. In the case where multiple units are to be updated with new firmware in a factory, retail setting, and/or home environment or during a development cycle, no setup for connection a computing device such as a PC to each individual unit will be involved.

FIG. 4 illustrates another method embodiment for performing firmware updates. As illustrated in block 410 of the embodiment in FIG. 4, the method includes using a memory card format to perform updates to a multimedia device. Further, as shown in block 420, the method includes performing all update operation local to a multimedia device.

As described above, program embodiments are provided to a multimedia device, e.g., storable on a memory of the multimedia device, that can be executed by a processor on the multimedia device to read a firmware version from a memory card in a memory card reader on the multimedia device. The program instructions are executed by the processor to select whether to update a firmware version in the memory of the multimedia device base on a comparison of the firmware version on the memory card to a firmware version in the memory of the multimedia device, e.g., digital media player. The program instructions further execute to afford a user the selectable option, e.g., a confirmation, of whether to proceed with the firmware update based a result of the comparison being presented to the user. The user can input instructions via a touch screen display and/or input keys on the multimedia device as well as via an RF remote control device. Embodiments are not limited to these examples.

Although specific embodiments have been illustrated and described herein, those of ordinary skill in the art will appreciate that any arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of skill in the art upon reviewing the above description. The scope of the various embodiments of the invention includes various other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A media receiver, comprising:
a processor;
a memory in communication with the processor;
a memory card reader in communication with the processor and memory; and
program instructions stored in memory and executable on the processor to update firmware on the media receiver based on a comparison of a firmware version read from a memory card in the memory card reader with a firmware version on the media receiver.

2. The media receiver of claim 1, wherein the memory card reader is a seven in one memory card reader.

3. The media receiver of claim 1, wherein the memory card includes a memory card selected from the group of:
a memory stick;
a secure digital card;
a compact flash card;
a smart media card;
an extreme digital picture card; and
a multimedia card.

4. A multimedia device, comprising:
a processor;
a memory in communication with the processor;
a memory card reader in communication with the processor and memory; and
program instructions stored in memory and executable on the processor to:
read a firmware version from a memory card in the memory card reader of the multimedia device; and
select whether to update a firmware version in the memory of the multimedia device based on a comparison of the firmware version on the memory card to the firmware version in the memory of the multimedia device.

5. The multimedia device of claim 4, wherein the memory card reader is capable of receiving and reading multiple memory card formats.

6. The multimedia device of claim 5, wherein the multiple memory card formats include formats associated with:
a memory stick;
a secure digital card;
a compact flash card;
a smart media card;
an extreme digital picture card; and
a multimedia card.

7. The multimedia device of claim 4, wherein the program instructions can execute to update a firmware version on the multimedia device without using wired connections to a host computer.

8. The multimedia device of claim 4, wherein the multimedia device includes a device selected from the group of:
a digital versatile disk player;
a digital camera;
an MP3 player;
a high definition television (HDTV);
a digital television; and
a HDTV tuner set top box.

9. The multimedia device of claim 8, wherein the multimedia device is capable of receiving and reading a firmware update without using a PC software utility.

10. The multimedia device of claim 8, wherein the multimedia device is capable of receiving and reading a firmware update without using a software utility configuration for baud rate, stop bit, and IP address information.

11. A multimedia device, comprising:
a processor;
a memory in communication with the processor; and
means for updating firmware on the multimedia device from a memory card.

12. The multimedia device of claim 11, wherein the means includes a memory card reader capable of reading multiple memory card formats.

13. The multimedia device of claim 12, wherein the means includes program instructions stored in memory and executable by the processor to read a firmware version stored on a memory card.

14. The multimedia device of claim 13, wherein the means includes program instructions stored in memory and executable by the processor to compare the firmware version read from the memory card in the memory card reader with a firmware version in the memory on the multimedia device.

15. The multimedia device of claim 14, wherein the multimedia device includes input and display means, and wherein the program instructions execute to select whether to update the firmware version in the memory on the multimedia device with the firmware version on the memory card based on user input to a result of version comparison.

16. The multimedia device of claim 15, wherein the input and display means includes a touch screen display on the multimedia device.

17. The multimedia device of claim 15, wherein the display means includes a television screen on a television set connected to the multimedia device and the input means is selected from the group of:
a remote control capable of interacting with the television set; and
an input button on the multimedia device.

18. A method for updating firmware to a multimedia device, comprising:
reading a firmware version from a memory card in a memory card reader of the multimedia device; and
selecting whether to update a firmware version in a memory of the multimedia device based on a comparison of the firmware version on the memory card to the firmware version in the memory of the multimedia device.

19. The method of claim 18, further including displaying a result from comparing the firmware version on the memory card to the firmware version in the memory of the multimedia device.

20. The method of claim 19, further including selecting whether to update the firmware version in the memory of the multimedia device based on user input to the multimedia device.

21. The method of claim 18, further including:
downloading a firmware update for the multimedia device to a hard disk of a personal computer via a network connection;
transferring the firmware update from the hard disk in the personal computer to a memory card via a memory card reader in the personal computer;
removing the memory card from the personal computer; and
mounting the memory card in the memory card reader of the multimedia device.

22. The method of claim 21, further including downloading the firmware update via an Internet connection.

23. A method for updating firmware to a multimedia device, comprising:
using a memory card format to perform firmware updates to a multimedia device; and
performing all update operations local to the multimedia device.

24. The method of claim 23, the method further including allowing a user to wirelessly provide input instructions to the multimedia device for selecting whether to perform a firmware update based on a comparison of a firmware version on the memory card to a firmware version resident in a memory of the multimedia device.

25. A computer readable medium having instructions for causing a multimedia device to perform a method, comprising:
reading a firmware version from a memory card in a memory card reader of the multimedia device; and
selecting whether to update a firmware version in a memory of the multimedia device based on a comparison of the firmware version on the memory card to the firmware version in the memory of the multimedia device.

26. The medium of claim 25, wherein the method further includes displaying a result from comparing the firmware version on the memory card to the firmware version in the memory of the multimedia device.

27. The medium of claim 26, wherein the method further includes initiating an update of the firmware version in the memory of the multimedia device based on user input to the multimedia device.

28. The medium of claim 25, wherein the method further includes wirelessly selecting whether to update the firmware version in the memory of the multimedia device with the firmware version on the memory card.
